(19) United States
(12) Patent Application Publication
(10) Pub. No.: US 2026/0021578 A1
(43) Pub. Date: Jan. 22, 2026

(54) SYSTEMS AND METHODS FOR FINGER GAITING SKILL LEARNING FOR MULTI-FINGERED ROBOTIC HANDS

(71) Applicants: Honda Motor Co., Ltd., Tokyo (JP); New York University, New York, NY (US)

(72) Inventors: Aadhithya Iyer, New York, NY (US); Jinda Cui, San Jose, CA (US); Irmak Guzey, New York, NY (US); Ben Evans, Brooklyn, NY (US); Naoki Morihira, Shiki City (JP); Karankumar Patel, San Jose, CA (US); Soshi Iba, Mountain View, CA (US); Lerrel Pinto, New York, NY (US)

(73) Assignees: Honda Motor Co., Ltd., Tokyo (JP); New York University, New York, NY (US)

(21) Appl. No.: 18/778,970

(22) Filed: Jul. 20, 2024

(51) Int. Cl. B25J 9/16; B25J 15/10

(52) U.S. Cl. CPC B25J 9/163; B25J 15/10

(57) ABSTRACT

A method for learning finger gaiting skills for multi-fingered robot hands may decompose a finger-gaiting task into shorter tasks by contact groups. The method may augment a reference trajectory for each shorter task. The method may use representation pretraining and exploration for learning.

### BACKGROUND

Dexterous manipulation has been studied for decades since the creation of multi-fingered robot hands. Progress generally has been made in model-based analytical methods with recent advancements in contact-mode-guided planning and auto-generation of manipulation primitives. However, perception and control challenges such as in-hand object tracking and contact servoing may still limit the real-world deployment of manipulation plans. Therefore, more and more studies have moved toward deep learning-based approaches in which perception, decision making, and control may be integrated together by neural function approximators.

Finger-gaiting may be a challenging subset of dexterous manipulation skills in which frequent contact switches may be coupled with pronounced changes in object poses during contact transitions. A successful finger-gaiting may require maintaining stable contacts with the object while moving other degrees of freedom to prepare for contact switch. The brittleness of contacts and the exploration in high dimensional action space may create great challenges in learning finger-gaiting skills. In prior work, reinforcement learning for in-hand object reorientation may have been attempted. While it may have achieved the task through intermittent contacts, human-like finger-gaiting skills didn't emerge even after long training sessions equivalent to years of exploration in the real world. Following this, a number of recent studies may have explored sim2real transfer, object rotation along predefined axes, and general in-hand reorientation for relatively small objects. So far, there has been no work showcasing learned finger-gaiting skills for challenging objects such as elongated objects which may require a large range of motion during contact switching.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for learning finger gaiting skills for multi-fingered robot hands is provided. The method may decompose a finger-gaiting task into shorter tasks by contact groups. The method may augment a reference trajectory for each shorter task. The method may further use representation pretraining and exploration for learning.

According to another embodiment of the disclosure, a method for learning finger gaiting skills for multi-fingered robot hands, the method implemented using a computer system including a processor communicatively coupled to a memory device is provided. The method may decompose long-horizon finger gating tasks into sequences of shorter-horizon tasks by treating each subsequent set of contacting bodies as a separate task. The method may augment a reference trajectory for each shorter task. The method may further use representation pretraining and exploration for learning.

According to an embodiment of the disclosure, a non-transitory computer readable medium comprising a plurality of instructions is disclosed. The plurality of instructions, when executed by a processor, may cause the processor to decompose long-horizon finger gating tasks into sequences of shorter-horizon tasks by treating desired movements in each subsequent set of contacting bodies as a separate task. The plurality of instructions, when executed by a processor, may cause the processor to augment a reference trajectory for each shorter task. The plurality of instructions, when executed by a processor, may cause the processor to use representation pretraining by pretraining on the reference trajectory of each shorter task. The plurality of instructions, when executed by a processor, may cause the processor to use exploration for learning by generating exploratory actions based on the reference trajectory of the shorter task.

### BRIEF DESCRIPTION OF THE DRAWINGS

FIG. 1A shows a side view of an exemplary robot hand in the initial configuration to perform a finger gating task, in accordance with an embodiment of the disclosure;

FIG. 1B shows top views of the finger gaiting task broken down into multiple phases divided by contact groups, in accordance with an embodiment of the disclosure;

FIG. 2 is a flowchart of an exemplary method for finger gaiting skill learning, in accordance with an embodiment of the disclosure; and

FIG. 3 is a block diagram of a computer-readable medium or computer-readable device including processor-executable instructions to embody the exemplary method shown in FIG. 2, in accordance with an embodiment of the disclosure; and

FIG. 4 is a block diagram of a computer system to embody the exemplary method shown in FIG. 2, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The present disclosure provides a novel approach to learn finger gaiting skills on multi-fingered robot hands from small amounts of expert demonstrations. The system and method may breakdown long-horizon finger gaiting tasks into composable, short-horizon primitive skills through a novel contact group concept. This design may be important to make the learning of finger gaiting skills tractable. The system and method may augment the reference trajectory for each primitive skill during training, which may expand the ways to compose the primitives together and provides the opportunity to interface with user specified commands. The system and method may customize the representation learning and exploration processes which may ensure learning efficiency.

Reference will now be made in detail to specific aspects or features, examples of which are illustrated in the accompanying drawings. Wherever possible, corresponding, or similar reference numbers will be used throughout the drawings to refer to the same or corresponding parts.

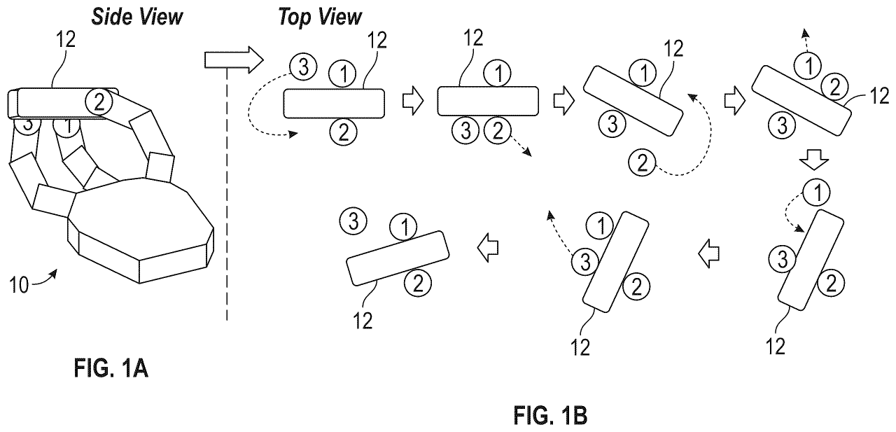

Referring to FIGS. 1A-1B, finger gaiting may involve making and breaking contacts during manipulation without losing control of an object 12. Finger gaiting may be a long-standing problem in dexterous manipulation for multi-fingered 1-3 robot hands 10. It may be rare to see any success in finger gaiting on real robots to this date, no matter using analytical or data-driven approaches. Given that deep learning has already shown encouraging results in object grasping and reorientation, finger-gaiting may be a next frontier to tackle.

Imitation learning (IL) has been successfully applied to solve complex tasks in the real world. The simplest form of IL may be Behavior Cloning (BC), which learns from offline expert demonstrations. It may be particularly effective with large datasets and may be applied to tasks with multimodal action distributions. However, it may suffer when the agent goes outside the domain of the demonstration dataset. Non-parametric models have been successfully applied to BC in the low-data regime, but they may lack a mechanism for updating the policy online.

Inverse reinforcement learning (IRL) may be a more sophisticated method that estimates the expert's reward function, enabling a policy to improve its performance using online interactions. IRL may be particularly useful when there are not a large number of expert demonstrations, but it may require that the agent to have access to online interactions with the environment. Many works have sought to improve the efficiency of IRL and to extend it to the visual imitation setting.

One approach that may have proven to be sample-efficient may be using residual reinforcement learning (residual RL), where an offline policy may serve as a base policy, and the online agent may finetune this policy through online interactions. This approach may enable online adaptation while remaining sample-efficient. The present system and method may utilize optimal transport residual IRL to efficiently learn a policy from visual and tactile inputs.

Robotic manipulation has traditionally focused on grasping objects, which may be formulated as a single-step problem of optimizing for stable points of contact or for target position and orientation. While some dexterous works may solve longer horizon manipulation tasks, they may treat the entire task as one long-horizon Reinforcement Learning (RL) problem, which may require decades of simulated experience, human demonstrations of the entire task, and may not reason about different modes of contact, which may force the learner to explore the state space blindly. From the theory literature for discrete Markov Decision Processes (MDPs), one may know that the number of samples required to optimally solve a task may scale quadratically with the horizon of the problem, which may suggest that short-horizon problems may be easier to solve. Additional empirical work may show that training over a wide initial state distribution may accelerate learning on long-horizon tasks.

Given these insights, one may propose decomposing long-horizon finger gating tasks, which may be characterized by complex subtask dependencies, into sequences of shorter-horizon tasks by treating each subsequent set of contacting bodies as a task. As may be shown in FIG. 1A-1B, the multi-fingered 1-3 robot hand 10 may manipulate the pose of the object 12. The different phases of the task (i.e., manipulating the pose of the object 12) performed by the robot hand 10 may be shown in FIG. 1B. Each phase may show a contact group and a trajectory of the fingers 1-3 that may not be in contact with the object 12. Similar to the present system and method may be OpenAI's work on solving a Rubik's Cube with a robot hand. In order to solve the long-horizon task, OpenAl may train two-policies, rotation and flip to rotate a single face of and flip the cube, chaining them together using a high-level planner. Instead of training policies to complete task-specific actions, the present system and method may learn sub policies to robustly transition between sets of contacting bodies. This decomposition may afford faster learning of sub-gaits, may reduce the amount of training data, may make use of sub-trajectories that do not solve the entire long-horizon task, and may allow for more effective exploration based on the current mode of contact.

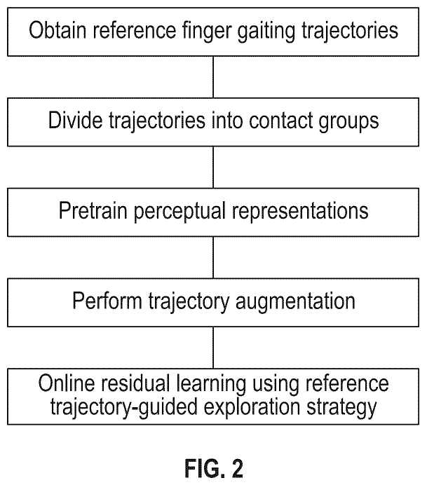

Referring to FIGS. 1A-2, the present system and method may start with a few reference trajectories Tref of the finger-gaiting task performed on the robot (can be achieved by kinesthetic teaching or other means of teleoperation).

To design the learning algorithms, one may need a conceptual tool to analyze the hybrid dynamical systems formed during finger gaiting tasks. A traditional contact mode-based analysis may often focus on the contact points on the object 12 being manipulated and may ignore the specificities of other bodies in contact (e.g., the robot) such as their geometry and actuation. However, such specificities may be important to learning-based approaches since they may affect the transition functions mapping from actions to object states.

The present system and method may propose a contact group concept which complements the limitation of contact modes. A contact group may be defined by the bodies (fingers 1-3 of the robot hand 10) in contact with the object 12. For convex contacts, all possible hand-object configurations in a contact group may be connected through contact mode transitions without breaking contact.

The contact group may have a natural connection to contact-maintaining exploration, i.e., the object may remain manipulatable/controllable during exploration, which may be the key to efficient and effective exploration for dexterous manipulation.

For each reference trajectory T_{ref}∈T_{ref} one may identify each contact group c_{T}∈C_{T} by the starting timestep t₀ and ending timestep tₑ (subscript for c_{T} may be omitted for simplicity). The trajectories decomposed by contact groups may be stated as T^{c}_{ref}. The labeling process may be manually done, or automated through contact detection.

One may adopt an online inverse reinforcement learning method, such as TAVI, as a learning backbone. Moreover, the backbone may use residual learning to further improve learning efficiency. Without manual reward design, TAVI may infer reward signals by comparing the last ten frames of the policy rollout to the last frame of the reference trajectory. The number of frames used in comparison may be a hyperparameter which may be tuned for better reward behavior.

Due to the long horizon nature of finger gaiting tasks, simply applying TAVI may be prone to contact breaking which may lead to unsuccessful training. In addition, variations for each contact transition may be insufficient to achieve robust finger gaiting policies.

Instead of training with the full trajectory T_{ref}, one may train with the decomposed trajectories T^{c}_{ref} using the backbone as may be shown in Algorithm 1 below. At the beginning of each episode, one may add domain randomization to object initial state and robot joint positions to cover the post image of the previous contact group.

Algorithm 1 Contact Group-Decomposed Online Training

| | |
|---|---|
| Input: π, [symbol] , [symbol] , [symbol] , [symbol] , env | [symbol] Policy π can be individual NNs for each c, or a single NN conditioned by c |

| | |
|---|---|
| Output: π | |
| for [symbol] ∈ [symbol] do | |
| for c_{τ} ∈ [symbol] do | |
| for: i ∈ {1, 2, ..., nₑₚₛ} do | [symbol] Loop through training episodes |
| $train\_aug ( π , {τ}_{ref}^{c} , {𝒟}_{c} , env ) run\_episode ( )$ | [symbol] Trajectory-augmented training in the next section |
| end for | |
| end for | |
| end for | |
| return π | |

[symbol]

indicates data missing or illegible when filed

One may reverse initial states and goal states as well as the reference trajectory for each primitive skill during training, which may expand the ways to compose the primitives together and may provide the opportunity to interface with user specified commands. See Algorithm 2 below for additional details.

Algorithm 2 Trajectory-augmented Training

| | |
|---|---|
| $\text{Input:} π , {τ}_{ref}^{c} , {𝒟}_{c} , env$ | |
| Output: π | |
| s ~ [symbol] | [symbol] Sample system initial configuration from the distribution |
| $τ = {τ}_{ref}^{c}$ | |
| env. [symbol] (s) | |
| backbone(π, env, τ, reversed = False).run_episode( ) | [symbol] The “reversed” flag is needed as a user-defined condition |
| s ~ reverse( [symbol] ) | |
| $τ = reverse ( {τ}_{ref}^{c} )$ | |
| env.reset(s) | |
| backbone(π, env, τ, reversed = True).run_episode( ) | |
| return π | |

[symbol]

indicates data missing or illegible when filed

One may build a task graph for user interactions, from which users may choose which primitive skill (skill within each contact group) to use and whether to pause or reverse the skill.

For representation learning, one may use a self-supervised representation pretraining procedure but with an option to be predicated by contact groups.

During online exploration, one may incentivize robot fingers in the contact group to stay close to the reference trajectory; and may encourage the other fingers to explore, such that they may bring the object back to a desired state or avoid unnecessary contacts in unexpected system configurations. Such an exploration strategy may be realized in many ways, e.g., using joint action differences in the reference trajectory to scale the exploration dimensions. See Algorithm 3 below for additional details.

Algorithm 3 Demo-guided Exploration

| | |
|---|---|
| $\text{Input:} π , 𝒪 , {τ}_{ref}^{c} , {𝒟}_{offset}$ | |
| Output: a | |
| a_{offset} ~ [symbol] _{offset} | [symbol] Sample offset action from a predefined distribution |
| ${α}_{offset} = update ( {α}_{offset} , {τ}_{ref}^{c} )$ | [symbol] Constrain the offset action based on the reference trajectory |
| a = π( [symbol] ) + a_{offset} | |
| return a | |

The present system and method may provide a novel approach to learn finger gaiting skills on multi-fingered robot hands using a small amount of expert demonstrations. The present system and method may decompose finger-gaiting tasks into primitives by contact group, may augment reference trajectory for user customizable skills, and may provide efficient representation learning and exploration processes tailored for finger gaiting tasks.

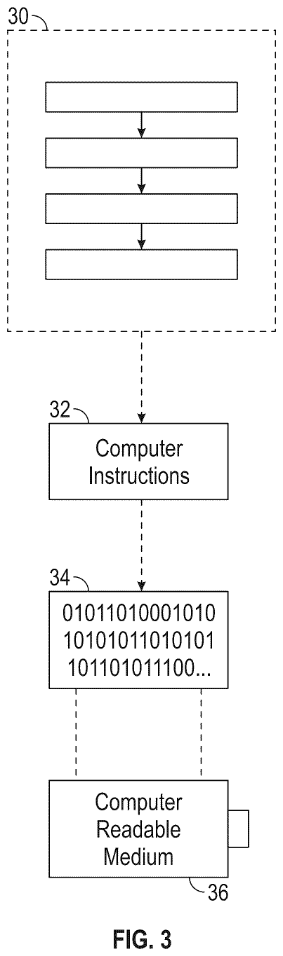

The present disclosure may also be embedded in a computer program product, which includes all the features that enable the implementation of the methods described herein, and which when loaded in a computer system is able to carry out these methods. Referring to FIG. 3, in this embodiment, the method shown in FIG. 2 and represented as 30 may include a computer-readable medium 36, such as a CD-R, DVD-R, flash drive, a platter of a hard disk drive, etc., on which may be encoded computer-readable data 34. This encoded computer-readable data 34, such as binary data may include a plurality of zero's and one's, in turn may include a set of processor-executable computer instructions 32 configured to operate according to one or more of the principles set forth herein. In this embodiment, the processor-executable computer instructions 32 may be configured to perform the method 30. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form.

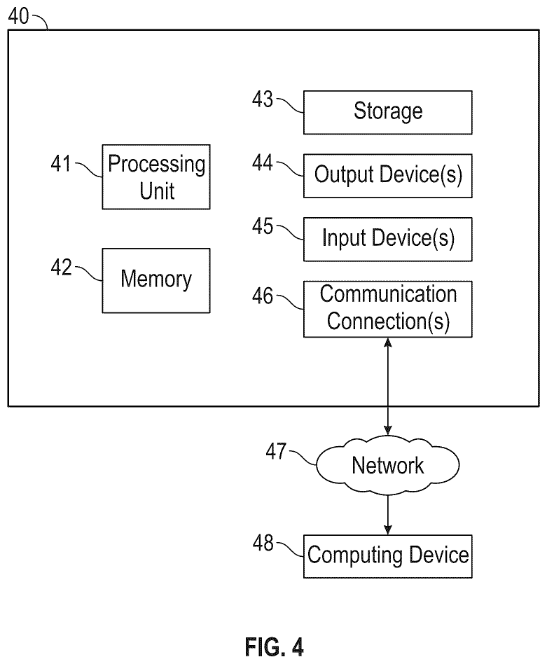

Referring to FIG. 4, a computing device 40 may be used to implement one aspect provided herein. In accordance with an embodiment, the computing device 40 may include at least one processing unit 41 and memory 42. Depending on the type of computing device, the memory 42 may be volatile, such as RAM, non-volatile, such as ROM, flash memory, etc., or a combination of the two.

In other aspects, the computing device 40 may include additional features or functionality. For example, the computing device 40 may include additional storage such as removable storage or non-removable storage, including, but not limited to, magnetic storage, optical storage, etc. Such additional storage may be illustrated in FIG. 4 by storage 43. In one embodiment, computer readable instructions to implement one aspect provided herein are in storage 43. Storage 43 may store other computer readable instructions to implement an operating system, an application program, etc. Computer readable instructions may be loaded in the memory 42 for execution by the processing unit 41, for example.

The computing device 40 may include input device(s) 44 such as keyboard, mouse, pen, voice input device, touch input device, infrared cameras, video input devices, or any other input device. Output device(s) 45 such as one or more displays, speakers, printers, or any other output device may be included with the computing device 40. Input device(s) 44 and output device(s) 45 may be connected to the computing device 40 via a wired connection, wireless connection, or any combination thereof. In one embodiment, an input device or an output device from another computing device may be used as input device(s) 44 or output device(s) 45 for the computing device 40. The computing device 40 may include communication connection(s) 46 to facilitate communications with one or more other devices 47, such as through network 47, for example.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims.

1. A method for learning finger gaiting skills for multi-fingered robot hands comprising:
decomposing a finger-gaiting task into shorter tasks by contact groups;
augmenting a reference trajectory for each shorter task; and
using representation pretraining and exploration for learning.

2. The method of claim 1, wherein decomposing reference finger-gaiting trajectories into shorter tasks by contact group comprises decomposing the finger-gaiting task into sequences of shorter tasks by treating each subsequent set of contacting bodies as a separate task.

3. The method of claim 1, customizing the representation pretraining and exploration processes for learning efficiency based on reference finger-gaiting trajectories.

4. The method of claim 1, comprising learning sub policies to transition between sets of contacting groups formed by decomposing the finger-gaiting task into shorter tasks by contact groups.

5. The method of claim 4, wherein each contact group is a set of bodies in contact such as the multi-fingered robot hand, the object, and the environment.

6. The method of claim 4, wherein for a desired contact group, the object remains manipulatable/controllable during exploration.

7. The method of claim 1, wherein tactile adaptation from visual incentives (TAVI) is used for learning.

8. The method of claim 7, comprising providing an option to be predicated by contact groups.

9. The method of claim 1, comprising adding domain randomization to an initial state of the object and robot joint positions to cover a post image of a previous contact group.

10. The method of claim 1, comprising reversing initial states, goal states, and reference trajectory for each primitive skill during training to expand ways to compose the primitive skill and to interface with user specified commands.

11. The method of claim 1, comprising providing a task graph for user interactions to choose a primitive skill to use and to pause or reverse the skill.

12. A method for learning finger gaiting skills for multi-fingered robot hands, the method implemented using a computer system including a processor communicatively coupled to a memory device, the method comprising:
decomposing long-horizon finger gating tasks into sequences of shorter-horizon tasks by treating each subsequent set of contacting bodies as a separate task;
augmenting a reference trajectory for each shorter task; and
using representation pretraining and exploration for learning.

13. The method of claim 12, comprising learning sub policies to transition between sets of contacting groups formed by decomposing the finger-gaiting task into shorter tasks by contact groups, wherein each contact group is a set of bodies in contact such as the multi-fingered robot hand, the object, and the environment.

14. The method of claim 12, wherein for a desired contact group, the object remains manipulatable/controllable during exploration.

15. The method of claim 12, comprising adding domain randomization to an initial state of the object and robot joint positions to cover a post image of a previous contact group.

16. The method of claim 12, comprising reversing initial states, goal states, and reference trajectory for each primitive skill during training to expand ways to compose the primitive skill and to interface with user specified commands.

17. The method of claim 12, wherein tactile adaptation from visual incentives (TAVI) is used for learning.

18. The method of claim 12, comprising providing a task graph for user interactions to choose a primitive skill to use and to pause or reverse the skill.

19. A non-transitory computer readable medium comprising a plurality of instructions which, when executed by a processor, cause the processor to:
decompose long-horizon finger gating tasks into sequences of shorter-horizon tasks by treating desired movements in each subsequent set of contacting bodies as a separate task;
augment a reference trajectory for each shorter task; and
use representation pretraining and exploration by pretraining on the reference trajectory of each shorter task; and
use exploration for learning by generating exploratory actions based on the reference trajectory of the shorter task.

20. The non-transitory computer readable medium according to claim 19, wherein the instructions, when executed by the processor, causes the processor to provide a task graph for user interactions to choose a primitive skill to use and to pause or reverse the skill.
